(19) United States
(12) Patent Application Publication
(10) Pub. No.: US 2023/0179040 A1
(43) Pub. Date: Jun. 8, 2023

(54) BRUSHLESS MORTOR

(71) Applicant: MITSUBA Corporation, Gunma (JP)

(72) Inventors: HIROTO TANAKA, Gunma (JP); TAKUMI ARAO, Gunma (JP); TAKAMASA AOKI, Gunma (JP)

(73) Assignee: MITSUBA Corporation, Gunma (JP)

(21) Appl. No.: 17/917,001

(22) PCT Filed: Sep. 7, 2021
(86) PCT No.: PCT/JP2021/032754

§ 371 Date: Oct. 5, 2022

(30) Foreign Application Priority Data
Oct. 22, 2020 (JP) 2020-177333

(51) Int. Cl. H02K 1/276

(52) U.S. Cl. CPC H02K 1/276

(57) ABSTRACT

A brushless motor includes a rotor, the rotor including magnets and a core member. The magnets are arranged around a rotating shaft and sequentially arrayed with N poles or S poles facing each other in a circumferential direction. The core member includes: an annular portion around the rotating shaft; an outer peripheral core part which supports the magnets on an outer peripheral side of the annular portion; and bridges which extend radially between the annular portion and the outer peripheral core part. Each of the bridges is positioned between the magnets adjacent to each other in the circumferential direction. The bridges include one or more first bridges extending over a first range corresponding to a partial range of the core member along a direction of the rotating shaft.

### TECHNICAL FIELD

The present invention relates to a brushless motor including a rotor.

### RELATED ART

A brushless motor is known to include a plurality of magnets arrayed in a circumferential direction centered on a rotating shaft and a rotor core which holds the magnets. Patent Document 1 discloses a brushless motor in which a plurality of core pieces are combined to form a rotor core.

### RELATED ART DOCUMENT

### Patent Document

Patent Document 1: Japanese Patent Application Laid-Open No. 2013-123365

### SUMMARY OF INVENTION

### Problem to Be Solved by Invention

When a rotor core is configured by combining a plurality of core pieces, it becomes difficult to ensure the assembly precision as the number of core pieces increases. Moreover, if the number of types of core pieces increases, the corresponding number of molds is also required, resulting in poor productivity.

The present invention has been made to solve the above problem and an objective thereof is to provide a brushless motor in which the number and types of members constituting a rotor can be reduced.

### Means for Solving Problem

To solve the above problem, an embodiment of the present invention provides a brushless motor including a rotor, the rotor including a plurality of magnets and a core member. The plurality of magnets are arranged around a rotating shaft and sequentially arrayed with N poles or S poles facing each other in a circumferential direction. The core member includes: an annular portion around the rotating shaft; an outer peripheral core part which supports the plurality of magnets on an outer peripheral side of the annular portion; and a plurality of bridges which extend radially between the annular portion and the outer peripheral core part. Each of the plurality of bridges is positioned between the magnets adj acent to each other in the circumferential direction. The plurality of bridges include one or more first bridges extending over a first range corresponding to a partial range of the core member along a direction of the rotating shaft.

### Effects of Invention

According to the present invention, the number and types of members constituting the rotor can be reduced.

### BRIEF DESCRIPTION OF DRAWINGS

FIG. 1 is a cross-sectional view of an electromagnetic steel sheet constituting a core member and magnets of a rotor in a first embodiment.

FIG. 1A is a cross-sectional view of the rotor taken in a plane including a rotating shaft.

FIG. 1B is a perspective view showing the core member of the rotor.

FIG. 1C is a view showing an example in which a first bridge and a second bridge are unevenly distributed in an axial direction.

FIG. 1D is a view showing an example in which the angle of the electromagnetic steel sheets is shifted every two sheets.

FIG. 2 is a cross-sectional view of an electromagnetic steel sheet constituting a core member and magnets of a rotor in a second embodiment.

FIG. 2A is a cross-sectional view of an electromagnetic steel sheet constituting a core member and magnets of a rotor in a second embodiment.

FIG. 2B is a cross-sectional view showing the rotor (cross-sectional view taken along line IIb-IIb of FIG. 2 and FIG. 2A).

FIG. 3 is a cross-sectional view of an electromagnetic steel sheet constitute a core member and magnets of a rotor in a third embodiment.

FIG. 3A is a cross-sectional view showing the rotor.

FIG. 3B is a perspective view showing the rotor.

FIG. 3C is a view showing an example in which a first bridge and a second bridge are unevenly distributed in an axial direction.

FIG. 3D is a view showing an example in which the angle of the electromagnetic steel sheets is shifted every two sheets.

FIG. 4 is a view showing a leakage magnetic flux of the magnet in a core member obtained by laminating only the electromagnetic steel sheets.

FIG. 5 is a cross-sectional view of an electromagnetic steel sheet constituting a core member and magnets of a rotor in a fourth embodiment.

FIG. 6 is a cross-sectional view of an electromagnetic steel sheet constituting a core member and magnets of a rotor in a fifth embodiment.

FIG. 7 is a perspective view showing a rotor in a sixth embodiment.

FIG. 8 is a plan view showing an electromagnetic steel sheet which constitutes a core member.

FIG. 9 is a perspective view showing a magnet holder.

FIG. 10 is a plan view showing the magnet holder.

### DESCRIPTION OF EMBODIMENTS

Hereinafter, embodiments of the present invention will be described with reference to the drawings.

### First Embodiment

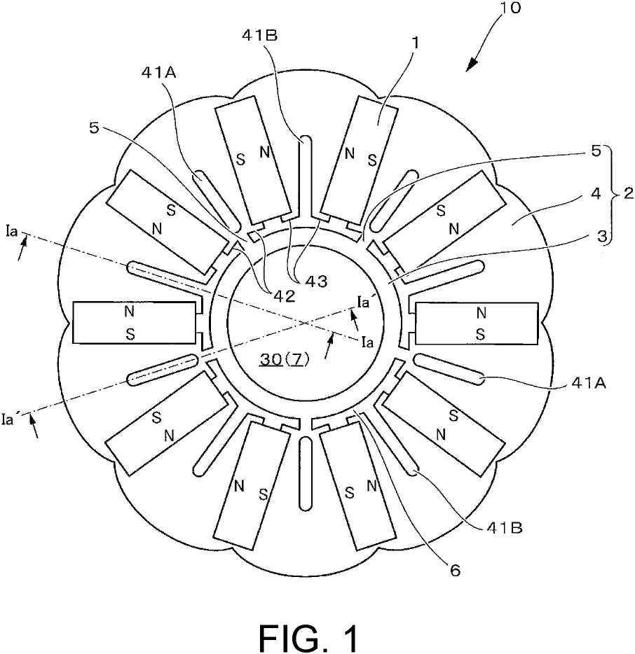

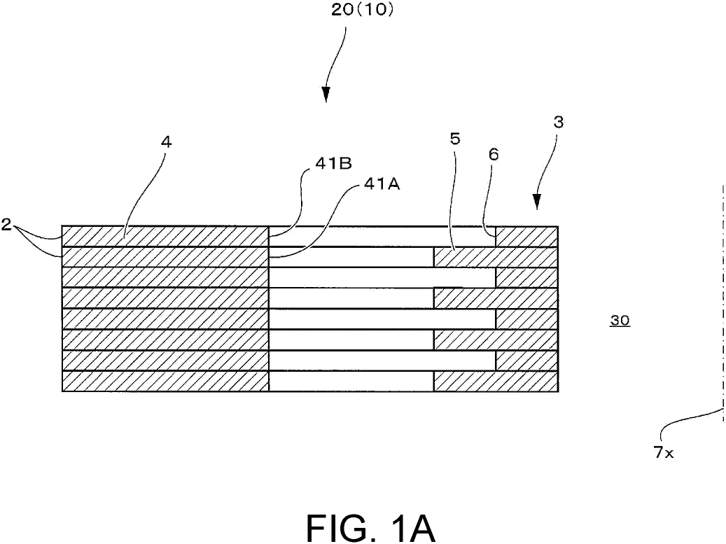

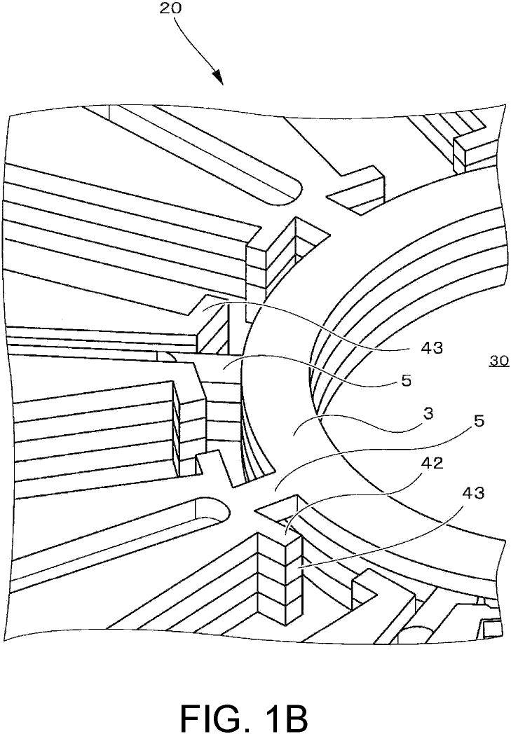

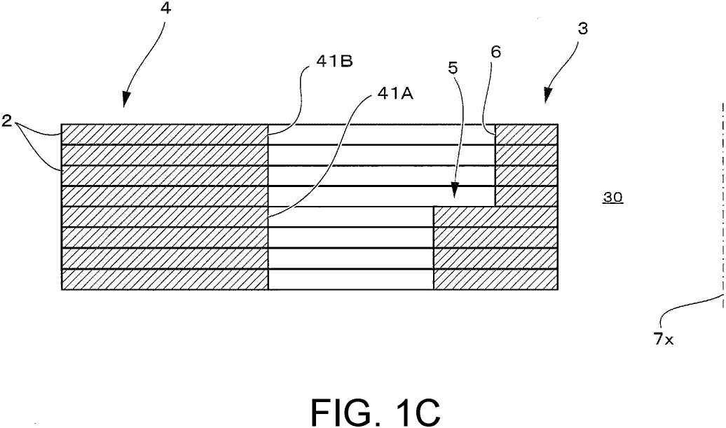

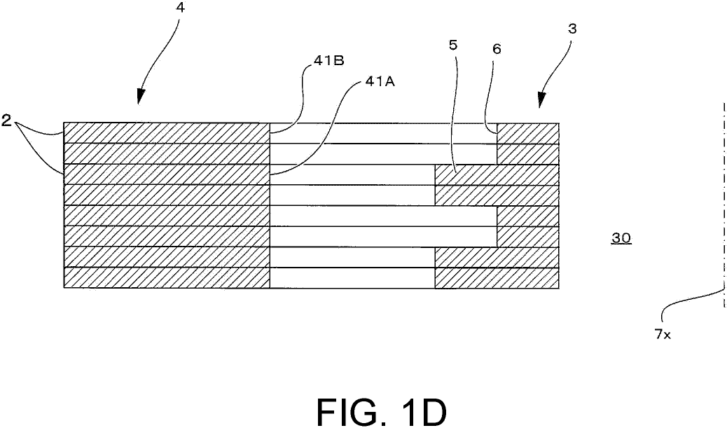

FIG. 1 is a cross-sectional view of an electromagnetic steel sheet constituting a core member and magnets of a rotor in a first embodiment. FIG. 1A is a cross-sectional view of the rotor taken in a plane including a rotating shaft. FIG. 1B is a perspective view showing the core member of the rotor.

A brushless motor of this embodiment is, for example, a three-phase brushless motor having a U-phase, a V-phase, and a W-phase. The brushless motor is of an inner rotor type which includes a rotor 10 (FIG. 1) and a stator (not shown), with the rotor 10 being arranged on the inner side of the stator.

In this embodiment, a 10-pole motor is exemplified, but the number of poles is not limited in the brushless motor of the present invention, and the number of slots is arbitrary. The same applies to other embodiments.

The rotor 10 is rotatably supported around a rotating shaft 7. In the following description, a radial direction, a circumferential direction, an inner side, and an outer side are defined based on the rotating shaft 7.

The rotor 10 includes a plurality of rectangular parallelepiped-shaped magnets 1 arranged around the rotating shaft 7 and sequentially arrayed with N poles or S poles facing each other in the circumferential direction, and a core member 20 which supports the plurality of magnets 1. The magnets 1 are arranged at equal angular intervals (36° in the example of FIG. 1 and FIG. 1B) around the rotating shaft 7 so that one plane of the magnet 1 faces the rotating shaft 7. The magnetic material of the magnet 1 is not limited, and neodymium-based, ferrite-based, and other magnetic materials may be used. Also, the magnet 1 may be a sintered magnet or a bonded magnet.

The core member 20 is configured by laminating electromagnetic steel sheets 2 in the axial direction of the rotating shaft 7. The electromagnetic steel sheet 2 may be formed by a press with high working precision, and its shape is defined at high precision.

The electromagnetic steel sheet 2 includes an annular portion 3 around the rotating shaft 7, an outer peripheral core part 4 which supports the plurality of magnets 1 on the outer peripheral side of the annular portion 3, and a plurality of bridges 5 which radially extend between the annular portion 3 and the outer peripheral core part 4. Each of the plurality of bridges 5 is positioned between magnets 1 adjacent to each other in the circumferential direction. An annular portion, an outer peripheral core part, and bridges of the core member 20 are respectively constituted by the annular portions 3, the outer peripheral core parts 4, and the bridges 5 of the plurality of laminated electromagnetic steel sheets 2. The rotating shaft 7 is fitted into an opening 30 formed on the inner peripheral side of the annular portion 3.

As shown in FIG. 1, the five bridges 5 formed on the electromagnetic steel sheet 2 are arranged around the rotating shaft 7 at equal angular intervals of every two poles (72° in the example of FIG. 1 and FIG. 1B).

In addition, a slit 41A or a slit 41B which extends in the radial direction is formed at angular intervals of every two poles (72° in the example of FIG. 1 and FIG. 1B) between magnets 1 adjacent to each other in the circumferential direction. The slit 41A is formed at the same position as the bridge 5 in the circumferential direction. Moreover, the slit 41B is formed at a position where the bridge 5 is not formed in the circumferential direction, and is connected to a notch 6 at a radially inner peripheral side end. The notch 6 is formed in an annular shape extending in the circumferential direction in a circumferential range excluding a portion connected by the bridge 5, and magnetically separates the annular portion 3 and the outer peripheral core part 4. The slit 41A and the slit 41B magnetically separate the outer peripheral core part 4 in the circumferential direction.

The outer peripheral core part 4 of the electromagnetic steel sheet 2 is provided with a contact part 42 (an example of an inner peripheral contact part) and a contact part 43 (an example of an inner peripheral contact part) which support the magnet 1 from the inner peripheral side. The contact part 42 extends from an outer peripheral end of the bridge 5 to two sides in the circumferential direction and contacts a surface of the magnet 1 on the inner peripheral side. Further, the contact part 43 extends from the vicinity of an inner peripheral end of the slit 41B to two sides in the circumferential direction and contacts the surface of the magnet 1 on the inner peripheral side. In this manner, the contact part 42 and the contact part 43 respectively contact the inner peripheral surface of each magnet 1 on two sides of each magnet 1 in the circumferential direction.

As shown in FIG. 1A and FIG. 1B, in this embodiment, the electromagnetic steel sheets 2 are sequentially laminated while shifting the angle of the electromagnetic steel sheet 2 around the rotating shaft 7 by an angle of an odd number of poles, e.g., by one pole (36° in the example of FIG. 1 and FIG. 1B). Accordingly, the bridges 5 positioned in the same direction in the circumferential direction alternately appear on every other sheet of the electromagnetic steel sheets 2. FIG. 1A shows a cross section taken in a plane passing through an axis 7x of the rotating shaft 7, for example, and a cross section of each electromagnetic steel sheet 2 taken on line Ia-Ia or line Ia′-Ia′ in FIG. 1 appears alternately in the direction of the axis 7x. In other words, a first bridge composed of a group of the bridges 5 (shown in FIG. 1A) of the electromagnetic steel sheets 2 located on the second, fourth, sixth, and eighth sheets sequentially from the top in FIG. 1A, and a second bridge composed of a group of the bridges 5 (not shown in FIG. 1A) of the electromagnetic steel sheets 2 located on the first, third, fifth, and seventh sheets sequentially from the top in FIG. 1A are alternately formed at angles shifted by one pole (36° in the example of FIG. 1 to FIG. 1B) in the circumferential direction.

FIG. 1A shows an example in which the core member 20 is configured by laminating eight electromagnetic steel sheets 2 and FIG. 1B shows an example in which the core member 20 is configured by laminating four electromagnetic steel sheets 2, but the number of electromagnetic steel sheets 2 is arbitrary. The same applies to other embodiments. Also, the number of bridges formed on the electromagnetic steel sheet is not limited and may be any number (one or more). The number of bridges may be reduced as long as the strength of the core member is ensured.

FIG. 1C and FIG. 1D are views showing an example in which the method of laminating the electromagnetic steel sheets is changed.

FIG. 1C shows an example in which the first bridge and the second bridge are unevenly distributed in the direction of the axis 7x. In this example, a first bridge composed of a group of the bridges 5 (shown in FIG. 1C) of the electromagnetic steel sheets 2 located on the fifth, sixth, seventh, and eighth sheets sequentially from the top in FIG. 1C, and a second bridge composed of a group of the bridges 5 (not shown in FIG. 1C) of the electromagnetic steel sheets 2 located on the first, second, third, and fourth sheets sequentially from the top in FIG. 1C are formed unevenly on the upper and lower sides in the direction of the axis 7x.

FIG. 1D shows an example in which the angle of the electromagnetic steel sheets 2 is shifted every two sheets. In the example of FIG. 1D, a first bridge composed of a group of the bridges 5 (shown in FIG. 1D) of the electromagnetic steel sheets 2 located on the third, fourth, seventh, and eighth sheets sequentially from the top in FIG. 1D, and a second bridge composed of a group of the bridges 5 (not shown in FIG. 1D) of the electromagnetic steel sheets 2 located on the first, second, fifth, and sixth sheets sequentially from the top in FIG. 1D are formed at angles shifted by one pole in the circumferential direction.

According to the above embodiment (FIG. 1 to FIG. 1D), since the core member 20 may be configured by laminating only the electromagnetic steel sheets 2, the number and types of members which constitute the rotor 10 can be reduced. Therefore, high assembly precision can be obtained, and costs can be reduced by reducing the number of mold types. In addition, since the magnet 1 is not exposed to the inner peripheral side (rotating shaft 7 side) of the core member 20, damage to the magnet 1 can be prevented.

Furthermore, since the magnet 1 is covered with the outer peripheral core part 4 from the outer peripheral side, it is possible to prevent minute magnet fragments generated by cracking and chipping of the magnet 1 from entering between the rotor 10 and the stator. Therefore, a highly reliable motor can be obtained without problems such as the rotor 10 being locked.

### Second Embodiment

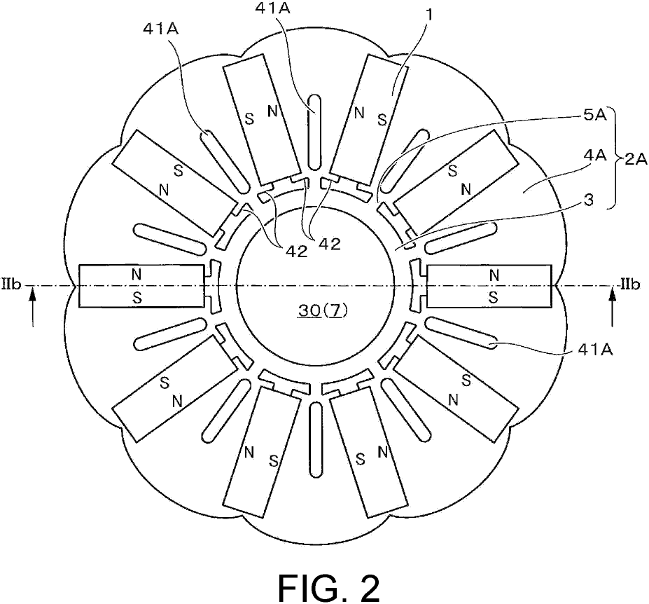

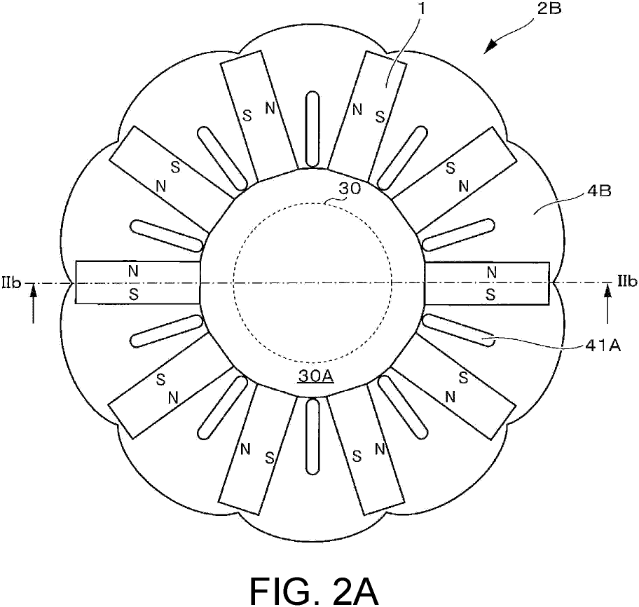

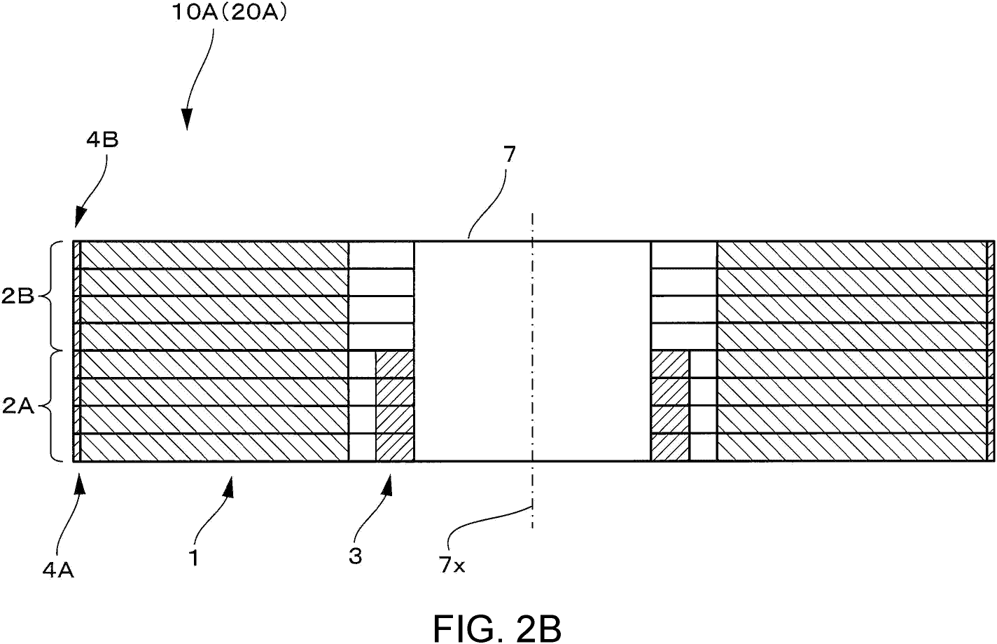

FIG. 2 and FIG. 2A are cross-sectional views of an electromagnetic steel sheet constituting a core member and magnets of a rotor in a second embodiment. FIG. 2B is a cross-sectional view showing the rotor (cross-sectional view taken along line IIb-IIb of FIG. 2 and FIG. 2A).

In this embodiment, a core member 20A of a rotor 10A is configured by laminating an electromagnetic steel sheet 2A (an example of a first member) shown in FIG. 2 and an electromagnetic steel sheet 2B (an example of a second member) shown in FIG. 2A. The electromagnetic steel sheet 2A and the electromagnetic steel sheet 2B may be formed by a press with high working precision, and their shapes are defined at high precision.

As shown in FIG. 2, the electromagnetic steel sheet 2A includes an annular portion 3 around the rotating shaft 7, an outer peripheral core part 4A which supports a plurality of magnets 1 on the outer peripheral side of the annular portion 3, and a plurality of bridges 5A which extend radially between the annular portion 3 and the outer peripheral core part 4A. Each of the plurality of bridges 5A is positioned between magnets 1 adjacent to each other in the circumferential direction. An annular portion of the core member 20A is configured by the annular portions 3 of the plurality of laminated electromagnetic steel sheets 2A. An outer peripheral core part of the core member 20A is configured by the outer peripheral core parts 4A and outer peripheral core parts 4B of the plurality of laminated electromagnetic steel sheets 2A and electromagnetic steel sheets 2B. Bridges of the core member 20A is configured by bridges 5A of the plurality of laminated electromagnetic steel sheets 2A. Further, the rotating shaft 7 is fitted into an opening 30 formed on the inner peripheral side of the annular portions 3 of the plurality of laminated electromagnetic steel sheets 2A.

As shown in FIG. 2, the ten bridges 5A formed on the electromagnetic steel sheet 2A are arranged around the rotating shaft 7 at equal angular intervals of one pole (36° in the example of FIG. 2).

Further, a slit 41A which extends radially is formed at angular intervals of one pole (36° in the example of FIG. 2) between magnets 1 adjacent to each other in the circumferential direction. The slit 41A is formed at the same position as the bridge 5A in the circumferential direction.

The outer peripheral core part 4A of the electromagnetic steel sheet 2A is provided with a contact part 42 which supports the magnet 1 from the inner peripheral side. The contact part 42 extends from an outer peripheral end portion of the bridge 5A to two sides in the circumferential direction and contacts the surface of the magnet 1 on the inner peripheral side. The contact part 42 contacts the inner peripheral surface of each magnet 1 on two sides of each magnet 1 in the circumferential direction.

As shown in FIG. 2A, the electromagnetic steel sheet 2B includes an outer peripheral core part 4B which supports the plurality of magnets 1, and an opening 30A is formed at a portion corresponding to the annular portion 3 and the bridges 5A of the electromagnetic steel sheet 2A. That is, the electromagnetic steel sheet 2B does not include elements corresponding to the annular portion 3 and the bridges 5A.

The slit 41A which extends radially is formed at angular intervals of one pole (36° in the example of FIG. 2A) between magnets 1 adjacent to each other in the circumferential direction. The slit 41A is formed at the same position as on the electromagnetic steel sheet 2A.

As shown in FIG. 2B, the core member 20A is configured by laminating the electromagnetic steel sheets 2A and the electromagnetic steel sheets 2B. In the example of FIG. 2B, four continuously laminated electromagnetic steel sheets 2A and four continuously laminated electromagnetic steel sheets 2B are laminated and fixed with each other to form the core member 20A. The core member 20A composed of the electromagnetic steel sheets 2A and the electromagnetic steel sheets 2B is fixed to the rotating shaft 7 by fitting the rotating shaft 7 into the opening 30 at the center of the electromagnetic steel sheets 2A.

Bridges of the core member 20A are configured by the bridges 5A of the electromagnetic steel sheets 2A. Since the bridges 5A are formed only on the electromagnetic steel sheets 2A, the bridges of the core member 20A are formed unevenly on the lower side in FIG. 2B.

Similar to the first embodiment, in the second embodiment, the method of laminating the electromagnetic steel sheets 2A and the electromagnetic steel sheets 2B is not limited, and the laminating method may be selected arbitrarily. For example, a predetermined number (one or more) of the laminated electromagnetic steel sheets 2A and a predetermined number (one or more) of the laminated electromagnetic steel sheets 2B may be alternately stacked in the direction of the axis 7x.

According to the above embodiment (FIG. 2 to FIG. 2B), since the core member 20A may be configured by laminating only the electromagnetic steel sheets 2A and the electromagnetic steel sheets 2B, the number and types of members that constitute the rotor 10A can be reduced. Therefore, high assembly precision can be obtained, and costs can be reduced by reducing the number of mold types. Moreover, since the magnet 1 is not exposed to the inner peripheral side (rotating shaft 7 side) of the core member 20A, damage to the magnet 1 can be prevented.

Furthermore, since the magnet 1 is covered from the outer peripheral side by the outer peripheral core part 4A and the outer peripheral core part 4B, it is possible to prevent minute magnet fragments generated by cracking and chipping of the magnet 1 from entering between the rotor 10A and the stator. Therefore, a highly reliable motor can be obtained without problems such as the rotor 10A being locked.

### Third Embodiment

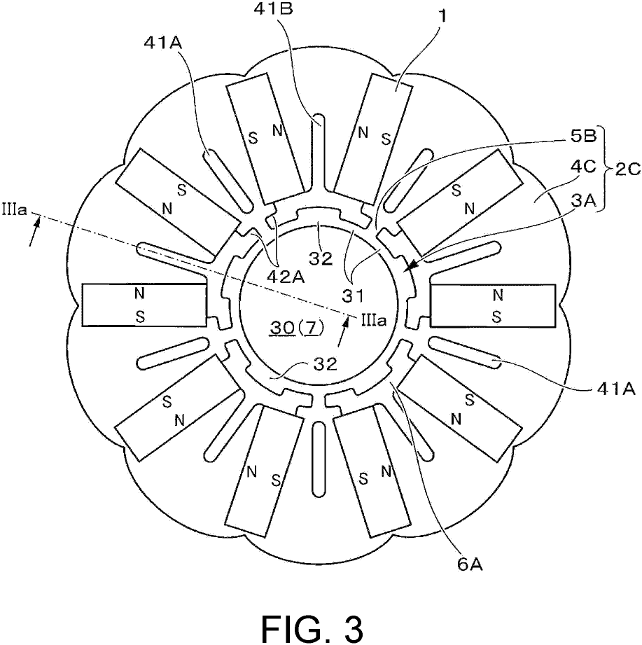

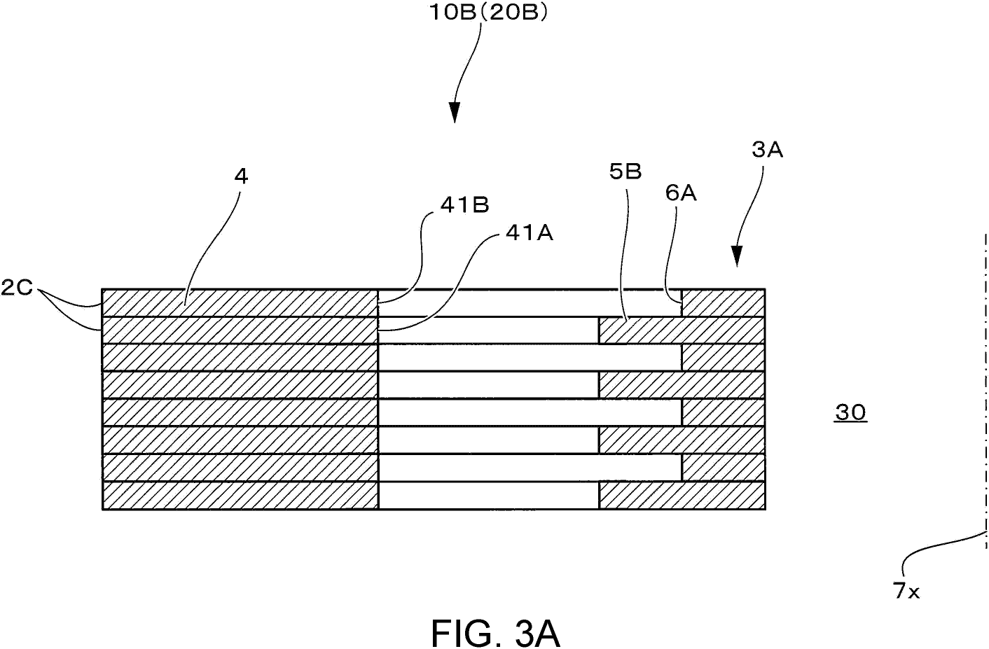

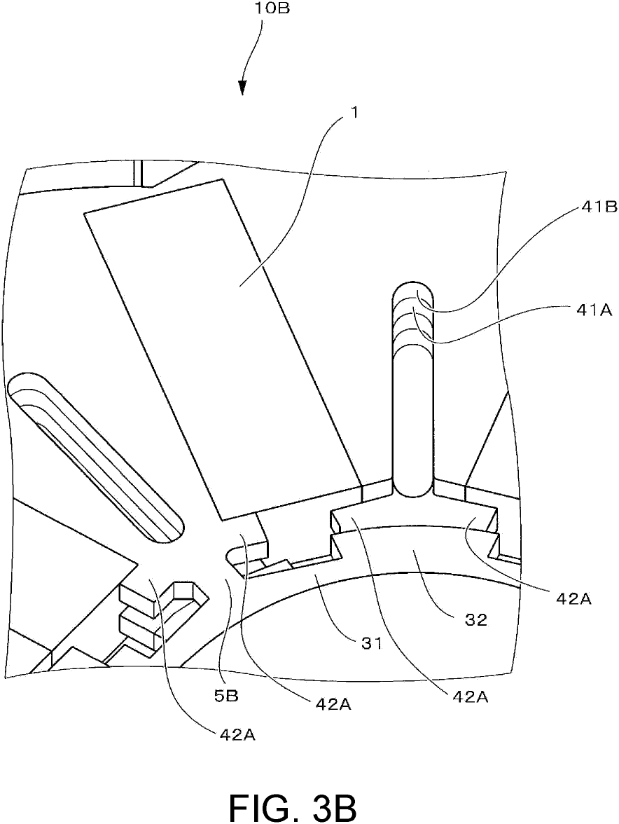

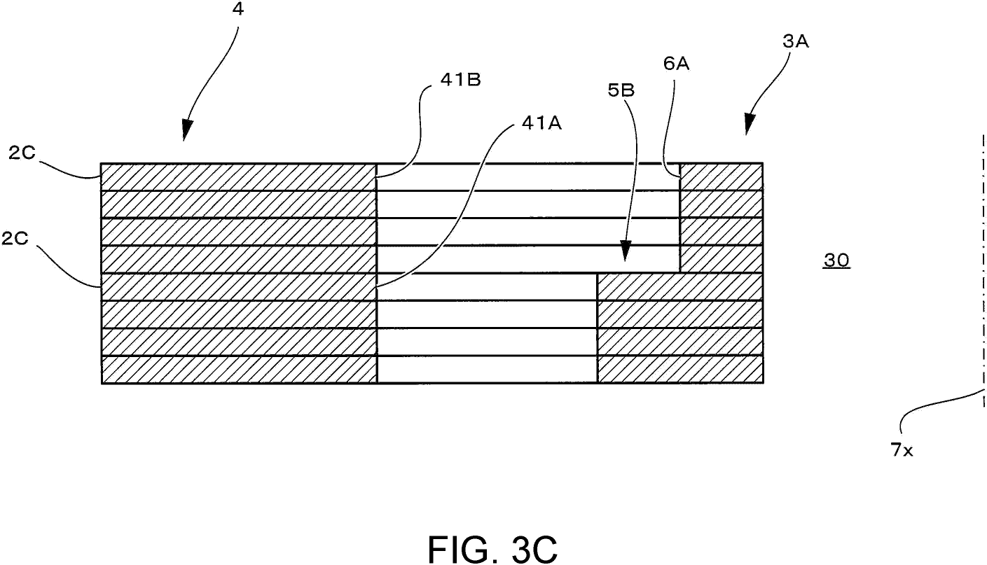

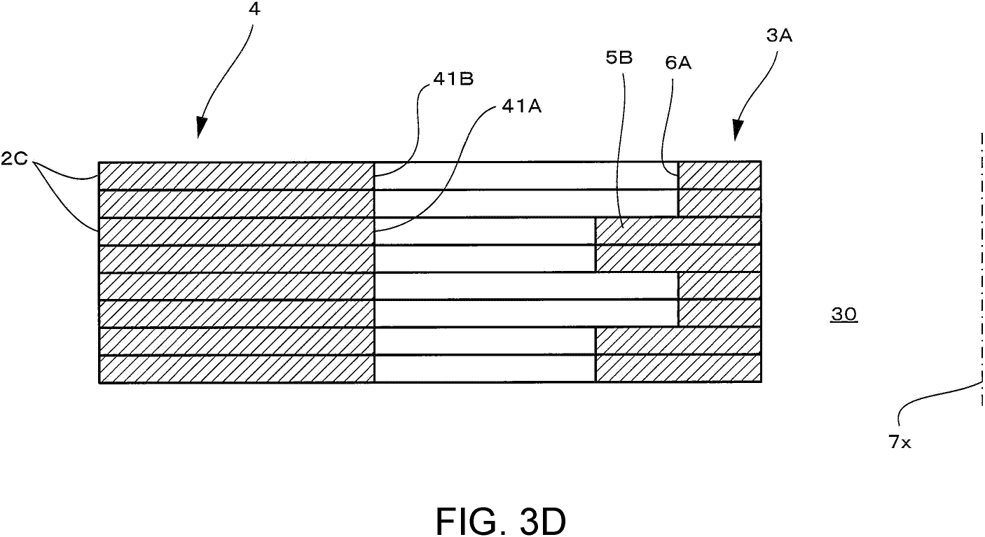

FIG. 3 is a cross-sectional view of an electromagnetic steel sheet constituting a core member and magnets of a rotor in a third embodiment. FIG. 3A is a cross-sectional view showing the rotor. FIG. 3B is a perspective view showing the rotor.

A rotor 10B includes a plurality of rectangular parallelepiped-shaped magnets 1 arranged around a rotating shaft 7 and sequentially arrayed with N poles or S poles facing each other in the circumferential direction, and a core member 20B which supports the plurality of magnets 1. The magnets 1 are arranged at equal angular intervals (36° in the example of FIG. 3 to FIG. 3B) around the rotating shaft 7 so that one plane of the magnet 1 faces the rotating shaft 7.

The core member 20B is configured by laminating electromagnetic steel sheets 2C in the axial direction of the rotating shaft 7. The electromagnetic steel sheet 2C may be formed by a press with high working precision, and its shape is defined with high precision.

As shown in FIG. 3, the electromagnetic steel sheet 2C includes an annular portion 3A around the rotating shaft 7, an outer peripheral core part 4C which supports the plurality of magnets 1 on the outer peripheral side of the annular portion 3A, and a plurality of bridges 5B which extend radially between the annular portion 3A and the outer peripheral core part 4C. Each of the plurality of bridges 5B is positioned between magnets 1 adjacent to each other in the circumferential direction. An annular portion, an outer peripheral core part, and bridges of the core member 20B are respectively configured by the annular portions 3A, the outer peripheral core parts 4C, and the bridges 5B of the plurality of laminated electromagnetic steel sheets 2C. The rotating shaft 7 is fitted into an opening 30 formed on the inner peripheral side of the annular portion 3A.

As shown in FIG. 3, the five bridges 5B formed on the electromagnetic steel sheet 2C are arranged around the rotating shaft 7 at equal angular intervals of every two poles (72° in the example of FIG. 3 to FIG. 3B).

In addition, a slit 41A or a slit 41B which extends radially is formed at angular intervals of every two poles (72° in the example of FIG. 3 to FIG. 3B) between magnets 1 adjacent to each other in the circumferential direction. The slit 41A is formed at the same position as the bridge 5B in the circumferential direction. Moreover, the slit 41B is formed at a position where the bridge 5B is not formed in the circumferential direction, and is connected to a notch 6A at a circumferential end. The notch 6A is formed in an annular shape extending in the circumferential direction in a circumferential range excluding a portion connected by the bridge 5B, and magnetically separates the annular portion 3A and the outer peripheral core part 4C. The slit 41A and the slit 41B magnetically separate the outer peripheral core part 4C in the circumferential direction.

The outer peripheral core part 4B of the electromagnetic steel sheet 2C is provided with a contact part 42A (an example of an inner peripheral contact part) which supports the magnet 1 from the inner peripheral side. The contact part 42A extends from an outer peripheral end portion of the bridge 5B to two sides in the circumferential direction and contacts the surface of the magnet 1 on the inner peripheral side.

In this embodiment, the contact part 42A contacts the inner peripheral surface of each magnet 1 only on one side of each magnet 1 in the circumferential direction. As shown in FIG. 3, each magnet 1 is supported from the inner peripheral side only on one side of each magnet 1 in the circumferential direction. Therefore, to increase the strength of the contact part 42A which supports the magnet 1, the radial width of the contact part 42A is made larger than that of the contact part 42 (FIG. 1). Correspondingly, the annular portion 3A includes a portion 31 having a narrowed radial width to ensure a distance from the contact part 42A, and a portion 32 having a radial width wider than that of the portion 31 to ensure the strength of the annular portion 3A as a whole. In this embodiment, since there is no contact part corresponding to the contact part 43 in FIG. 1, the portion 32 of the annular portion 3A can be expanded radially outward, and the radial width at the portion 32 can be sufficiently ensured.

As shown in FIG. 3A, in this embodiment, similar to the first embodiment, the electromagnetic steel sheets 2C are sequentially laminated while shifting the angle of the electromagnetic steel sheet 2C around the rotating shaft 7 by an angle of an odd number of poles, e.g., by one pole (36° in the example of FIG. 3). Accordingly, the bridges 5B positioned in the same direction in the circumferential direction alternately appear on every other sheet of the electromagnetic steel sheets 2C.

FIG. 3A shows a cross section taken in a plane passing through the axis 7x of the rotating shaft 7 (cross section taken along line IIIa-IIIa in FIG. 3). A first bridge composed of a group of the bridges 5B (shown in FIG. 3A) of the electromagnetic steel sheets 2C located on the second, fourth, sixth, and eighth sheets sequentially from the top in FIG. 3A, and a second bridge composed of a group of the bridges 5B (not shown in FIG. 3A) of the electromagnetic steel sheets 2C located on the first, third, fifth, and seventh sheets sequentially from the top in FIG. 3A are alternately formed at angles shifted by one pole (36° in the example of FIG. 3 and FIG. 3B) in the circumferential direction.

Similar to the first embodiment, in the third embodiment, the method of laminating the electromagnetic steel sheets 2C is not limited, and the laminating method may be arbitrarily selected.

FIG. 3C shows an example in which the first bridge and the second bridge are unevenly distributed in the direction of the axis 7x. In this example, a first bridge composed of a group of the bridges 5B (shown in FIG. 3C) of the electromagnetic steel sheets 2C located on the fifth, sixth, seventh, and eighth sheets sequentially from the top in FIG. 3C, and a second bridge composed of a group of the bridges 5B (not shown in FIG. 3C) of the electromagnetic steel sheets 2C located on the first, second, third, and fourth sheets sequentially from the top in FIG. 3C are formed unevenly on the upper and lower sides in the direction of the axis 7x.

FIG. 3D shows an example in which the angle of the electromagnetic steel sheets 2C is shifted every two sheets. In the example of FIG. 3D, a first bridge composed of a group of the bridges 5B (shown in FIG. 3D) of the electromagnetic steel sheets 2C located on the third, fourth, seventh, and eighth sheets sequentially from the top in FIG. 3D, and a second bridge composed of a group of the bridges 5B (not shown in FIG. 3D) of the electromagnetic steel sheets 2C located on the first, second, fifth, and sixth sheets sequentially from the top in FIG. 3D are formed at angles shifted by one pole in the circumferential direction.

According to the above embodiment (FIG. 3 to FIG. 3D), since the core member 20B may be configured by laminating only the electromagnetic steel sheets 2C, the number and types of members that constitute the rotor 10B can be reduced. Therefore, high assembly precision can be obtained, and costs can be reduced by reducing the number of mold types. Moreover, since the magnet 1 is not exposed to the inner peripheral side (rotating shaft 7 side) of the core member 20B, damage to the magnet 1 can be prevented.

Furthermore, since the magnet 1 is covered from the outer peripheral side by the outer peripheral core part 4C, it is possible to prevent minute magnet fragments generated by cracking and chipping of the magnet 1 from entering between the rotor 10B and the stator. Therefore, a highly reliable motor can be obtained without problems such as the rotor 10B being locked.

### Effect of Torque Increase in Each Embodiment

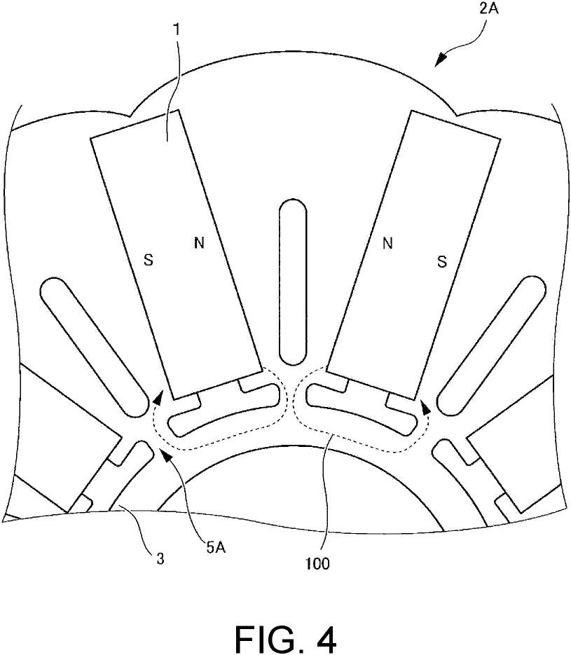

FIG. 4 is a view showing a leakage magnetic flux of the magnet in a core member obtained by laminating only the electromagnetic steel sheets 2A shown in FIG. 2. A leakage magnetic flux 100 indicates a magnetic flux leaking from the magnet 1 to the inner peripheral side via the bridge 5A and the annular portion 3. As shown in FIG. 4, in the electromagnetic steel sheet 2A, the leakage magnetic flux 100 toward the inner peripheral side is uniformly generated in all the magnets 1 arrayed in the circumferential direction.

In contrast, in the first embodiment, since the bridges 5 of the electromagnetic steel sheet 2 are thinned out, a magnetic flux path corresponding to the leakage magnetic flux 100 (FIG. 4) is not formed in the electromagnetic steel sheet 2. Therefore, in the first embodiment, a leakage magnetic flux from the magnet 1 toward the inner peripheral side can be reduced. According to a magnetic field analysis result, a ratio of an induced voltage in the case of using the core member 20 can be increased by about 2.1% compared to the case of using the core member obtained by laminating only the electromagnetic steel sheets 2A.

Similarly, in the third embodiment, since the bridges 5B of the electromagnetic steel sheet 2C are thinned out, a magnetic flux path corresponding to the leakage magnetic flux 100 (FIG. 4) is not formed in the electromagnetic steel sheet 2C. Therefore, in the third embodiment, a leakage magnetic flux from the magnet 1 toward the inner peripheral side can be reduced. According to a magnetic field analysis result, a ratio of an induced voltage in the case of using the core member 20B can be increased by about 2.7% compared to the case of using the core member obtained by laminating only the electromagnetic steel sheets 2A.

Further, in the second embodiment, the core member 20A includes the electromagnetic steel sheet 2B in which an annular portion and bridges are not present. Therefore, a magnetic flux path corresponding to the leakage magnetic flux 100 (FIG. 4) can be reduced in the core member 20A as a whole, and a leakage magnetic flux from the magnet 1 toward the inner peripheral side can be reduced.

Accordingly, according to each of the above-described embodiments, a leakage magnetic flux from the magnet 1 toward the inner peripheral side can be reduced. Therefore, the induced voltage increases, and the torque of the motor can be increased. Further, by reducing the leakage magnetic flux from the magnet 1, a demagnetization temperature of the magnet 1 can be increased.

### Fourth Embodiment

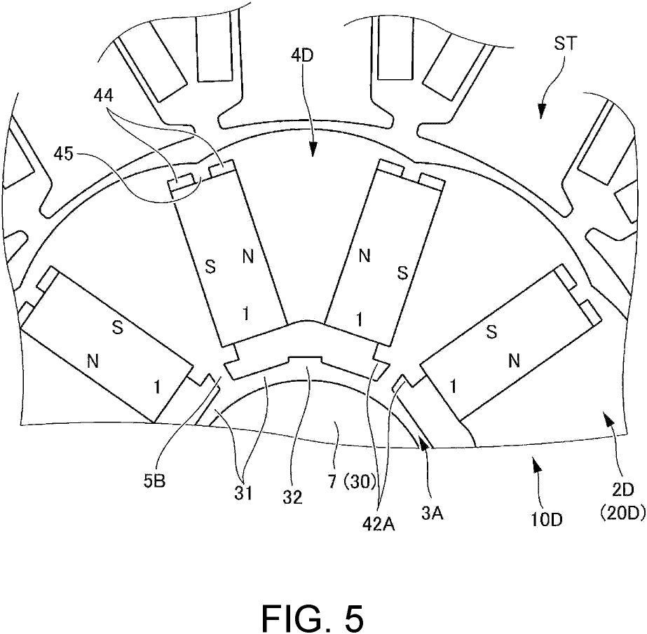

FIG. 5 is a cross-sectional view of an electromagnetic steel sheet constituting a core member and magnets of a rotor in a fourth embodiment. In FIG. 5, elements corresponding to those of the third embodiment (FIG. 3 to FIG. 3B) are labeled with the same reference signs as in FIG. 3 to FIG. 3B.

As shown in FIG. 5, a rotor 10D is arranged around a rotating shaft 7 on the inner peripheral side of a stator ST. The rotor 10D includes a plurality of rectangular parallelepiped-shaped magnets 1 sequentially arrayed with N poles or S poles facing each other in the circumferential direction, and a core member 20D which supports the plurality of magnets 1. The magnets 1 are arranged at equal angular intervals (36° in the example of FIG. 5) around the rotating shaft 7 so that one plane of the magnet 1 faces the rotating shaft 7.

The core member 20D is configured by laminating electromagnetic steel sheets 2D in the axial direction of the rotating shaft 7. The electromagnetic steel sheet 2D may be formed by a press with high working precision, and its shape is defined at high precision.

The electromagnetic steel sheet 2D includes an annular portion 3A around the rotating shaft 7, an outer peripheral core part 4D which supports the plurality of magnets 1 on the outer peripheral side of the annular portion 3A, and a plurality of bridges 5B which extend radially between the annular portion 3A and the outer peripheral core part 4D. Each of the plurality of bridges 5B is positioned between magnets 1 adjacent to each other in the circumferential direction. An annular portion, an outer peripheral core part, and bridges of the core member 20D are respectively configured by the annular portions 3A, the outer peripheral core parts 4D, and the bridges 5B of the plurality of laminated electromagnetic steel sheets 2D. The rotating shaft 7 is fitted into an opening 30 formed on the inner peripheral side of the annular portion 3A.

As shown in FIG. 5, the five bridges 5B formed on the electromagnetic steel sheet 2D are arranged around the rotating shaft 7 at equal angular intervals of every two poles (72°).

The outer peripheral core part 4D of the electromagnetic steel sheet 2D is provided with a contact part 42A which supports the magnet 1 from the inner peripheral side. The contact part 42A extends from an outer peripheral end portion of the bridge 5B to two sides in the circumferential direction and contacts the surface of the magnet 1 on the inner peripheral side.

The contact part 42A contacts the inner peripheral surface of each magnet 1 only on one side of each magnet 1 in the circumferential direction. As shown in FIG. 5, each magnet 1 is supported from the inner peripheral side only on one side of each magnet 1 in the circumferential direction. Therefore, to increase the strength of the contact part 42A which supports the magnet 1, the radial width of the contact part 42A is made larger than that of the contact part 42 (FIG. 1). Correspondingly, the annular portion 3A includes a portion 31 having a narrowed radial width to ensure a distance from the contact part 42A, and a portion 32 having a radial width wider than that of the portion 31 to ensure the strength of the annular portion 3A as a whole. In this embodiment, since there is no contact part corresponding to the contact part 43 in FIG. 1, the portion 32 of the annular portion 3A can be expanded radially outward, and the radial width at the portion 32 can be sufficiently ensured.

In this embodiment, in the outer peripheral core part 4D, a pair of gap parts 44 forming a gap with respect to an outer peripheral end of each magnet 1 are formed for each magnet 1. A contact part 45 (an example of an outer peripheral contact part) is formed between the pair of gap parts 44 and protrudes from an outer peripheral side of an outer peripheral end of each magnet 1 toward the outer peripheral end of each magnet 1. The contact part 45 is in contact with the magnet 1 only at a portion of the outer peripheral end of each magnet 1. The pair of gap parts 44 are formed at a portion of the outer peripheral end of the magnet 1 where the contact part 45 is not in contact with the magnet 1.

In this embodiment, a predetermined number of electromagnetic steel sheets 2D having the same shape are laminated to form the core member 20D. Therefore, the contact part 45 extends in the axial direction, is provided only at a portion of the outer peripheral end of each magnet 1 in the circumferential direction, and contacts each magnet 1 only at this portion.

In this embodiment, since the core member 20D may be configured by laminating only the electromagnetic steel sheets 2D, the number and types of members that constitute the rotor 10D can be reduced. Therefore, high assembly precision can be obtained, and costs can be reduced by reducing the number of mold types. Moreover, since the magnet 1 is not exposed to the inner peripheral side (rotating shaft 7 side) of the core member 20D, damage to the magnet 1 can be prevented.

Furthermore, since the magnet 1 is covered from the outer peripheral side by the outer peripheral core part 4D, it is possible to prevent minute magnet fragments generated by cracking and chipping of the magnet 1 from entering between the rotor 10D and the stator ST. Therefore, a highly reliable motor can be obtained without problems such as the rotor 10D being locked.

Furthermore, in this embodiment, only the contact part 45 contacts the outer peripheral end of each magnet 1. Therefore, while ensuring the positional precision of the magnet 1 in the radial direction by the contact part 45, a gap is formed by the gap parts 44 between the outer peripheral end of the magnet 1 and the outer peripheral core part 4D. Accordingly, a leakage magnetic flux from the magnet 1 toward the outer peripheral side via the outer peripheral core part 4D can be reduced, and a demagnetization temperature of the magnet 1 can be increased. Therefore, a high-torque motor can be obtained. In particular, in this embodiment, since the contact part 45 contacts a central portion of the outer peripheral end of the magnet 1 in the circumferential direction, the leakage magnetic flux can be effectively reduced.

### Fifth Embodiment

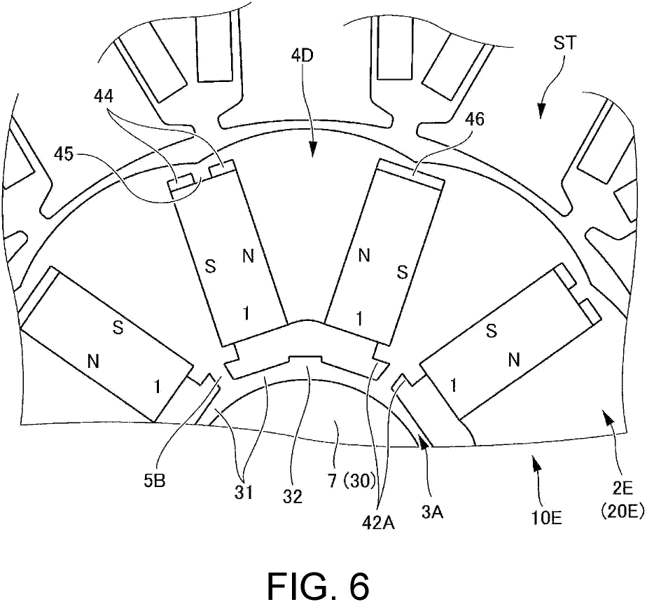

FIG. 6 is a cross-sectional view of an electromagnetic steel sheet constituting a core member and magnets of a rotor in a fifth embodiment. In FIG. 6, elements corresponding to those of the fourth embodiment (FIG. 5) are labeled with the same reference signs as in FIG. 5.

In this embodiment, a rotor 10E arranged on the inner peripheral side of a stator ST includes a plurality of rectangular parallelepiped-shaped magnets 1 arranged around a rotating shaft 7 and sequentially arrayed with N poles or S poles facing each other in the circumferential direction, and a core member 20E which supports the plurality of magnets 1. The magnets 1 are arranged at equal angular intervals (36°) around the rotating shaft 7 so that one plane of the magnet 1 faces the rotating shaft 7.

The core member 20E is configured by laminating electromagnetic steel sheets 2E in the axial direction of the rotating shaft 7. The electromagnetic steel sheet 2E may be formed by a press with high working precision, and its shape is defined at high precision.

The electromagnetic steel sheet 2E includes an annular portion 3A around the rotating shaft 7, an outer peripheral core part 4D which supports the plurality of magnets 1 on the outer peripheral side of the annular portion 3A, and a plurality of bridges 5B which extend radially between the annular portion 3A and the outer peripheral core part 4D. Each of the plurality of bridges 5B is positioned between magnets 1 adjacent to each other in the circumferential direction. An annular portion, an outer peripheral core part 4D, and bridges of the core member 20E are respectively configured by the annular portions 3A, the outer peripheral core parts 4D, and the bridges 5B of the plurality of laminated electromagnetic steel sheets 2E. The rotating shaft 7 is fitted into an opening 30 formed on the inner peripheral side of the annular portion 3A.

As shown in FIG. 6, the five bridges 5B formed on the electromagnetic steel sheet 2E are arranged around the rotating shaft 7 at equal angular intervals of every two poles (72°).

The outer peripheral core part 4D of the electromagnetic steel sheet 2E is provided with a contact part 42A which supports the magnet 1 from the inner peripheral side. The contact part 42A extends from an outer peripheral end portion of the bridge 5B to two sides in the circumferential direction and contacts the surface of the magnet 1 on the inner peripheral side.

The contact part 42A contacts the inner peripheral surface of each magnet 1 only on one side of each magnet 1 in the circumferential direction. As shown in FIG. 6, each magnet 1 is supported from the inner peripheral side only on one side of each magnet 1 in the circumferential direction. Therefore, to increase the strength of the contact part 42A which supports the magnet 1, the radial width of the contact part 42A is made larger than that of the contact part 42 (FIG. 1). Correspondingly, the annular portion 3A includes a portion 31 having a narrowed radial width to ensure a distance from the contact part 42A, and a portion 32 having a radial width wider than that of the portion 31 to ensure the strength of the annular portion 3A as a whole. In this embodiment, since there is no contact part corresponding to the contact part 43 in FIG. 1, the portion 32 of the annular portion 3A can be expanded radially outward, and the radial width at the portion 32 can be sufficiently ensured.

In this embodiment, a pair of gap parts 44 forming a gap with respect to the outer peripheral end of the magnet 1 are formed at angular intervals of every two poles (72°) at corresponding portions of the outer peripheral core part 4D of each electromagnetic steel sheet 2E. A contact part 45 is formed between the pair of gap parts 44 and protrudes from the outer peripheral side of the outer peripheral end of each magnet 1 toward the outer peripheral end of each magnet 1. The contact part 45 is in contact with the magnet 1 only at a portion of the outer peripheral end of each magnet 1. The pair of gap parts 44 are formed at portions of the outer peripheral end of the magnet 1 where the contact part 45 is not in contact with the magnet 1.

Further, a gap part 46 forming a gap with respect to the outer peripheral end of the magnet 1 is formed at angular intervals of every two poles (72°) at corresponding portions of the outer peripheral core part 4D. Different from the gap part 44, the gap part 46 is formed along the entire circumference of the outer peripheral end of the magnet 1. That is, a portion that contacts the outer peripheral end of the magnet 1 facing the gap part 46 is not formed on the electromagnetic steel sheet 2E.

As shown in FIG. 6, the pair of gap parts 44 with the contact part 45 and the gap part 46 are alternately formed in the circumferential direction at 36° intervals on each electromagnetic steel sheet 2E.

In this embodiment, the core member 20E is configured by laminating a predetermined number of the electromagnetic steel sheets 2E having the same shape while shifting the electromagnetic steel sheets 2E in the circumferential direction. For example, the electromagnetic steel sheets 2E are laminated in the axial direction at such angles that the pair of gap parts 44 with the contact part 45 and the gap part 46 are alternately overlapped. Therefore, the contact part 45 is provided only at a portion of the outer peripheral end of each magnet 1 in the circumferential direction and at a portion in the axial direction, and contacts each magnet 1 only at these portions. The method of shifting the electromagnetic steel sheets 2E in the circumferential direction may be arbitrary, but it is desirable to set the angle of each electromagnetic steel sheet 2E so that the contact part 45 contacts each magnet 1 evenly.

In this embodiment, since the core member 20E may be configured by laminating only the electromagnetic steel sheets 2E, the number and types of members that constitute the rotor 10E can be reduced. Therefore, high assembly precision can be obtained, and costs can be reduced by reducing the number of mold types. Moreover, since the magnet 1 is not exposed to the inner peripheral side (rotating shaft 7 side) of the core member 20E, damage to the magnet 1 can be prevented.

Furthermore, since the magnet 1 is covered from the outer peripheral side by the outer peripheral core part 4D, it is possible to prevent minute magnet fragments generated by cracking and chipping of the magnet 1 from entering between the rotor 10E and the stator ST. Therefore, a highly reliable motor can be obtained without problems such as the rotor 10E being locked.

Furthermore, in this embodiment, only the contact part 45 contacts the outer peripheral end of each magnet 1. Therefore, while ensuring the positional precision of the magnet 1 in the radial direction by the contact part 45, a gap composed of the gap part 44 and the gap part 46 is formed between the outer peripheral end of the magnet 1 and the outer peripheral core part 4D. Accordingly, a leakage magnetic flux from the magnet 1 toward the outer peripheral side via the outer peripheral core part 4D can be reduced, and a demagnetization temperature of the magnet 1 can be increased. Therefore, a high-torque motor can be obtained. In particular, in this embodiment, since the contact part 45 contacts the central portion of the outer peripheral end of the magnet 1 in the circumferential direction, the leakage magnetic flux can be effectively reduced. In this embodiment, a contact area of the contact part 45 with the outer peripheral end of the magnet 1 can be suppressed more than in the fourth embodiment. Therefore, the effect of reducing the leakage magnetic flux and the effect of increasing the demagnetization temperature can be further enhanced.

### Sixth Embodiment

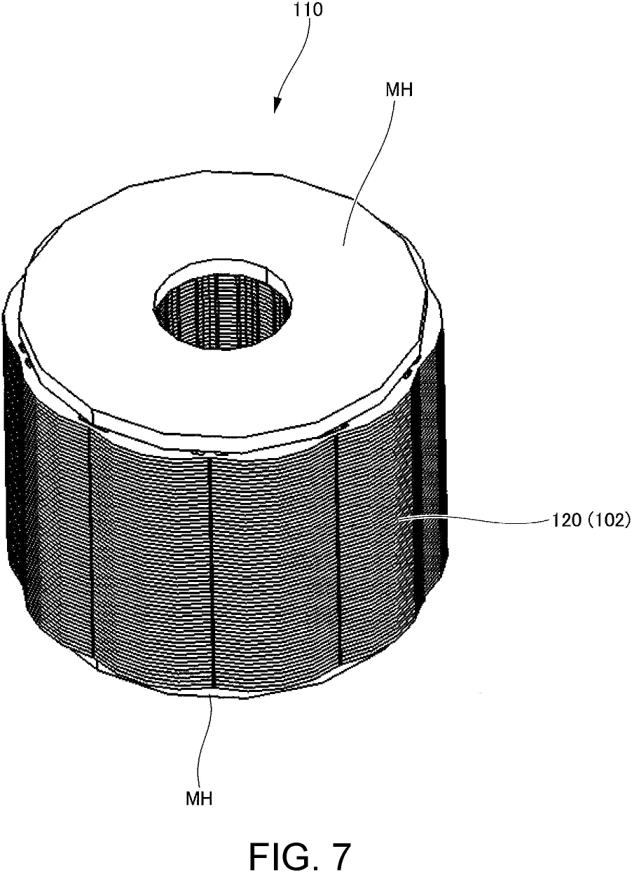

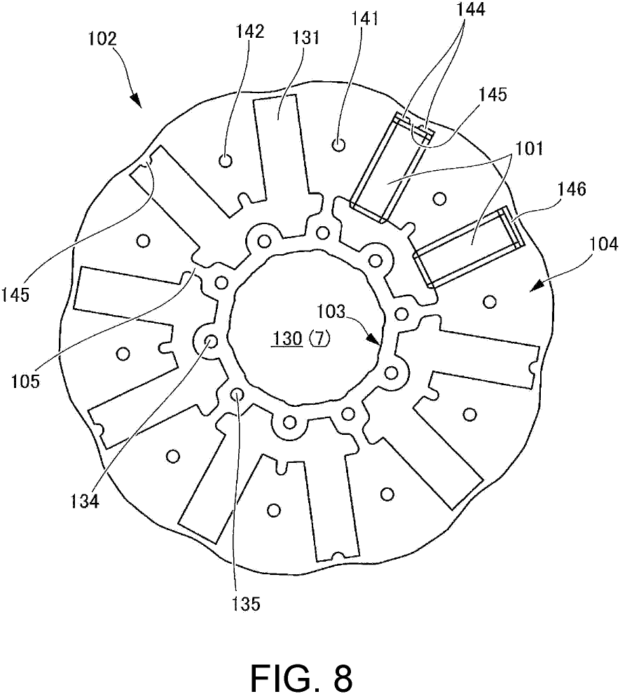

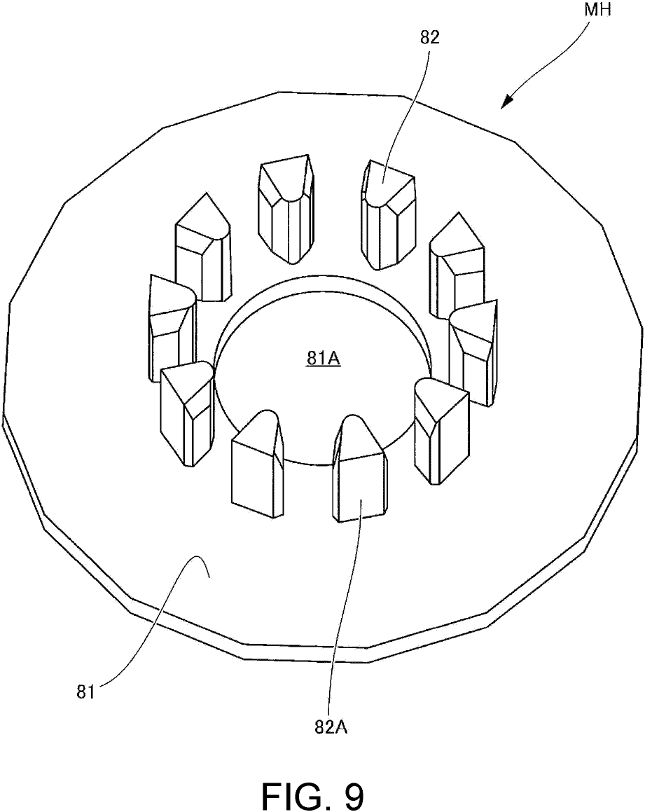

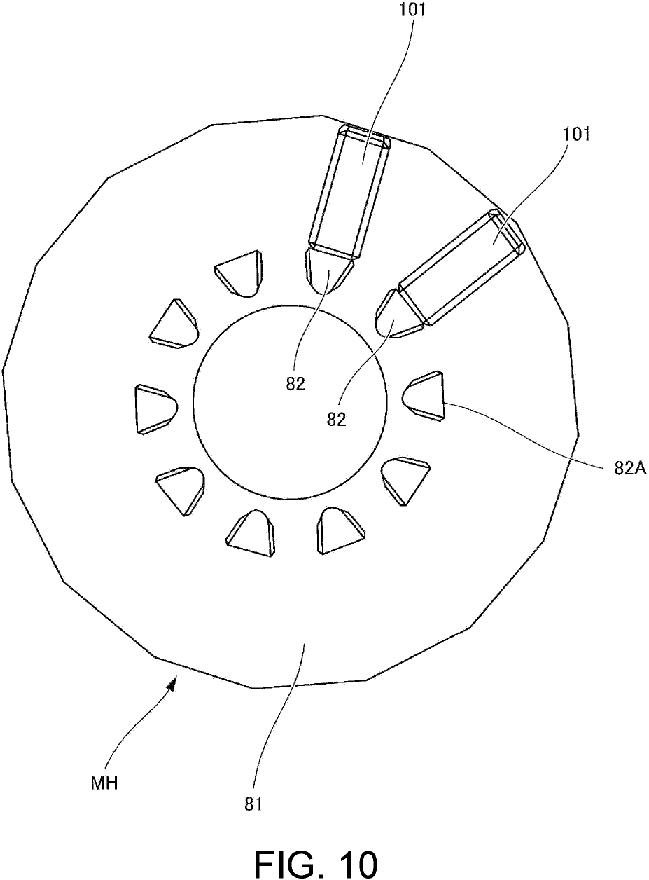

FIG. 7 is a perspective view showing a rotor in a sixth embodiment. FIG. 8 is a plan view showing an electromagnetic steel sheet which constitutes a core member. FIG. 9 is a perspective view showing a magnet holder. FIG. 10 is a plan view showing the magnet holder.

A brushless motor of this embodiment is, for example, a three-phase brushless motor having a U-phase, a V-phase, and a W-phase. The brushless motor is of an inner rotor-type which includes a rotor 110 and a stator (not shown), with the rotor 110 being arranged on the inner side of the stator.

In this embodiment, a 10-pole motor is exemplified, but the number of poles is not limited in the brushless motor of the present invention, and the number of slots is arbitrary. The same applies to other embodiments.

The rotor 110 is rotatably supported around a rotating shaft 7. In the following description, a radial direction, a circumferential direction, an inner side, and an outer side are defined based on the rotating shaft 7.

The rotor 110 includes a plurality of rectangular parallelepiped-shaped magnets 101 arranged around the rotating shaft 7 and sequentially arrayed with N poles or S poles facing each other in the circumferential direction, a core member 120 which supports the plurality of magnets 101, and a magnet holder MH made of resin arranged on two sides of the core member 120 in the axial direction. The magnets 101 are arranged at equal angular intervals (36°) around the rotating shaft 7 so that one plane of the magnet 101 faces the rotating shaft 7. The magnetic material of the magnet 101 is not limited, and neodymium-based, ferrite-based, and other magnetic materials may be used. Also, the magnet 101 may be a sintered magnet or a bonded magnet. In FIG. 8 and FIG. 10, only two magnets 101 are shown.

The core member 120 is configured by laminating electromagnetic steel sheets 102 in the axial direction of the rotating shaft 7. The electromagnetic steel sheet 102 may be formed by a press with high working precision, and its shape is defined at high precision.

The electromagnetic steel sheet 102 includes an annular portion 103 around the rotating shaft 7, an outer peripheral core part 104 which supports the plurality of magnets 101 on the outer peripheral side of the annular portion 103, and a plurality of bridges 105 which extend radially between the annular portion 103 and the outer peripheral core part 104. Each of the plurality of bridges 105 is positioned between magnets 101 adjacent to each other in the circumferential direction. An annular portion, an outer peripheral core part, and bridges of the core member 120 are respectively configured by the annular portions 103, the outer peripheral core parts 104, and the bridges 105 of the plurality of laminated electromagnetic steel sheets 102. The rotating shaft 7 (FIG. 8) is fitted into an opening 130 formed on the inner peripheral side of the annular portion 103. In FIG. 7, illustration of the rotating shaft 7 is omitted.

The five bridges 105 formed on the electromagnetic steel sheet 102 are arranged around the rotating shaft 7 at equal angular intervals of every two poles (72°).

A through-hole 131 penetrating in the axial direction is formed in the electromagnetic steel sheet 102, and the magnet 101 and a projecting part 82 of the magnet holder MH may be inserted into the through-hole 131. Further, an engaging part 141 and an engaging part 142 are formed in the outer peripheral core part 104 of the electromagnetic steel sheet 102. Further, an engaging part 134 and an engaging part 135 are formed in the annular portion 103 of the electromagnetic steel sheet 102. The engaging part 141, the engaging part 142, the engaging part 134, and the engaging part 135 are respectively formed as projections projecting axially or recesses recessed axially to engage axially adjacent electromagnetic steel sheets 102 with each other. Accordingly, the engaging part 141, the engaging part 142, the engaging part 134, and the engaging part 135 function as guides which define the radial and circumferential positions between the adjacent electromagnetic steel sheets 102.

As shown in FIG. 8, in this embodiment, a pair of gap parts 144 which form a gap with respect to the outer peripheral end of the magnet 101 are formed at angular intervals of two poles (72°) at corresponding portions of the outer peripheral core part 104 of each electromagnetic steel sheet 102. A contact part 145 is formed between the pair of gap parts 144 and protrudes from the outer peripheral side of the outer peripheral end of each magnet 101 toward the outer peripheral end of each magnet 101. The contact part 145 is in contact with the magnet 101 only at a portion of the outer peripheral end of each magnet 101. The pair of gap parts 144 are formed at a portion of the outer peripheral end of the magnet 101 where the contact part 145 is not in contact with the magnet 101.

Further, a gap part 146 which forms a gap with respect to the outer peripheral end of the magnet 101 is formed at angular intervals of two poles (72°) at corresponding portions of the outer peripheral core part 104. Different from the gap part 144, the gap part 146 is formed along the entire circumference of the outer peripheral end of the magnet 101. That is, a portion that contacts the outer peripheral end of the magnet 101 facing the gap part 146 is not formed on the electromagnetic steel sheet 102.

As shown in FIG. 8, in each electromagnetic steel sheet 102, the pair of gap parts 144 with the contact part 145 and the gap part 146 are alternately formed in the circumferential direction at 36° intervals.

In this embodiment, the core member 120 is configured by laminating a predetermined number of the electromagnetic steel sheets 102 having the same shape while shifting the electromagnetic steel sheets 102 in the circumferential direction. For example, the electromagnetic steel sheets 102 are laminated in the axial direction at such angles that the pair of gap parts 144 with the contact part 145 and the gap part 146 are alternately overlapped. Therefore, the contact part 145 is provided only at a portion of the outer peripheral end of each magnet 101 in the circumferential direction and at a portion in the axial direction, and contacts each magnet 101 only at these portions. The method of shifting the electromagnetic steel sheets 102 in the circumferential direction may be arbitrary, but it is desirable to set the angle of each electromagnetic steel sheet 102 so that the contact part 145 contacts each magnet 101 evenly.

In this embodiment, since the core member 120 may be configured by laminating only the electromagnetic steel sheets 102, the number and types of members that constitute the rotor 110 can be reduced. Therefore, high assembly precision can be obtained, and costs can be reduced by reducing the number of mold types. In addition, since the magnet 101 is not exposed to the inner peripheral side (rotating shaft 7 side) of the core member 120, damage to the magnet 101 can be prevented.

Furthermore, since the magnet 101 is covered from the outer peripheral side by the outer peripheral core part 104, it is possible to prevent minute magnet fragments generated by cracking and chipping of the magnet 101 from entering between the rotor 110 and the stator. Therefore, a highly reliable motor can be obtained without problems such as the rotor 110 being locked.

Furthermore, in this embodiment, only the contact part 145 contacts the outer peripheral end of each magnet 101. Therefore, while ensuring the positional precision of the magnet 101 in the radial direction by the contact part 145, a gap composed of the gap part 144 and the gap part 146 is formed between the outer peripheral end of the magnet 101 and the outer peripheral core part 104. Accordingly, a leakage magnetic flux from the magnet 101 toward the outer peripheral side via the outer peripheral core part 104 can be reduced, and a demagnetization temperature of the magnet 101 can be increased. Therefore, a high-torque motor can be obtained. In particular, in this embodiment, since the contact part 145 contacts the central portion of the outer peripheral end of the magnet 101 in the circumferential direction, the leakage magnetic flux can be effectively reduced.

As shown in FIG. 9 and FIG. 10, the magnet holder MH includes a plate-shaped part 81 formed with a hole 81A at the center through which the rotating shaft 7 penetrates, and ten projecting parts 82 arrayed in the circumferential direction and projecting from the plate-shaped part 81 in the axial direction. An outer peripheral surface 82A of the projecting part 82 is formed in a planar shape and supports the inner peripheral end (inner peripheral surface) of the magnet 101 from the inner peripheral side. As shown in FIG. 8, one magnet holder MH is attached to the core member 120 from two sides in the axial direction, with the plate-shaped part 81 being in contact with two axial end surfaces of the core member 120. The projecting part 82 is inserted into the through-hole 131 of the electromagnetic steel sheet 102. The axial length of the projecting part 82 is equal to or less than ½ of the axial length of the core member 120, and the projecting parts 82 of the two magnet holders MH do not interfere with each other.

At this time, as shown in FIG. 10, the inner peripheral surface of each magnet 101 may contact the outer peripheral surface 82A of the projecting part 82, and the magnet 101 is supported from the inner peripheral side by the outer peripheral surface 82A. Therefore, in this embodiment, the inner peripheral end (inner peripheral surface) of each magnet 101 does not contact the core member 120 and is separated from the core member 120 at a sufficient distance. Therefore, a leakage magnetic flux from the magnet 101 toward the inner peripheral side can be effectively suppressed.

Although the embodiments of the present invention have been described in detail above with reference to the drawings, the specific configurations are not limited to the embodiments but include designs and the like within the scope of the present invention.

In addition, the following appendices are further disclosed with respect to the above-described embodiments of the present invention.

### Appendix 1

A brushless motor including a rotor (10, 10A, 10B),
the rotor including:
   a plurality of magnets (1) arranged around a rotating shaft and sequentially arrayed with N poles or S poles facing each other in a circumferential direction; and
   a core member (20, 20A, 20B),
wherein the core member includes: an annular portion (3, 3A) around the rotating shaft; an outer peripheral core part (4, 4A, 4B) which supports the plurality of magnets on an outer peripheral side of the annular portion; and a plurality of bridges (5, 5A, 5B) which extend radially between the annular portion and the outer peripheral core part,
each of the plurality of bridges is positioned between the magnets adjacent to each other in the circumferential direction, and
the plurality of bridges include one or more first bridges (5, 5A, 5B) extending over a first range corresponding to a partial range of the core member along a direction of the rotating shaft.

According to the configuration of Appendix 1, since the plurality of bridges include one or more first bridges extending over a first range corresponding to a partial range of the core member along a direction of the rotating shaft, occurrence of a leakage magnetic flux toward the inner peripheral side of the magnet can be suppressed, and a high-torque motor can be obtained. In addition, since the core member may be configured using a small number of types of electromagnetic steel sheets, high assembly precision can be obtained, and costs can be reduced by reducing the number of mold types.

### Appendix 2

The brushless motor according to Appendix 1, wherein the brushless motor includes one or more second bridges (5, 5A, 5B) extending over a second range that corresponds to a partial range of the core member and is different from the first range along the direction of the rotating shaft.

According to the configuration of Appendix 2, since substantial cross-sectional areas in the radial direction of the first bridge and the second bridge can be reduced, a leakage magnetic flux of the magnet via the first bridge or the second bridge can be reduced.

### Appendix 3

The brushless motor according to Appendix 1, wherein the first bridge is provided to be unevenly distributed in one direction of a rotating shaft direction in the core member.

According to the configuration of Appendix 3, for example, by laminating the same electromagnetic steel sheets to be unevenly distributed in one direction, the first bridge can be formed.

### Appendix 4

The brushless motor according to Appendix 2, wherein the first bridge and the second bridge are alternately formed in the circumferential direction.

According to the configuration of Appendix 4, for example, by laminating the same electromagnetic steel sheets at alternating angles, the first bridge and the second bridge can be formed.

### Appendix 5

The brushless motor according to Appendix 1, wherein the outer peripheral core part includes an inner peripheral contact part (42A) which contacts the respective magnets from an inner peripheral side, and

the inner peripheral contact part is located at a same position as the first bridge in a rotating shaft direction and contacts an inner peripheral surface of the magnet only on one side adjacent to the first bridge in the circumferential direction.

According to the configuration of Appendix 5, the first bridge, and the inner peripheral contact part which contacts the inner peripheral surface of the magnet only on one side adjacent to the first bridge in the circumferential direction can be formed on one electromagnetic steel sheet.

### Appendix 6

The brushless motor according to Appendix 1, wherein the outer peripheral core part includes an inner peripheral contact part (42, 43) which contacts the respective magnets from an inner peripheral side, and

the inner peripheral contact part is located at a same position as the first bridge in a rotating shaft direction and contacts an inner peripheral surface of the magnet on two sides of the magnet in the circumferential direction.

According to the configuration of Appendix 6, the first bridge, and the inner peripheral contact part which contacts the inner peripheral surface of the magnet on two sides of the magnet in the circumferential direction can be formed on one electromagnetic steel sheet.

### Appendix 7

The brushless motor according to Appendix 1, wherein the core member includes:
a first member (2A) which constitutes the first bridge; and
a second member (2B) which includes the outer peripheral core part and does not include any of the annular portion and the plurality of bridges.

According to the configuration of Appendix 7, since the core member includes an electromagnetic steel sheet which does not include any of the annular portion and the plurality of bridges, occurrence of a leakage magnetic flux toward the inner peripheral side of the magnet can be suppressed, and a high-torque motor can be obtained.

### Appendix 8

The brushless motor according to any one of Appendices 1 to 7, wherein the outer peripheral core part is formed with a gap part (44, 46) which forms a gap with respect to an outer peripheral end of the magnet.

According to the configuration of Appendix 8, since a gap is formed between the outer peripheral end of the magnet and the outer peripheral core part by the gap part, occurrence of a leakage magnetic flux toward the outer peripheral side of the magnet can be suppressed, and a high-torque motor can be obtained.

### Appendix 9

The brushless motor according to any one of Appendix 8, wherein the outer peripheral core part is formed with an outer peripheral contact part (45) which contacts the magnet at a portion of the outer peripheral end of the magnet, and

the gap part is formed at a portion of the outer peripheral end of the magnet where the outer peripheral contact part is not in contact with the magnet.

According to the configuration of Appendix 9, since the contact part contacts a portion of the outer peripheral end of the magnet and the gap part is formed at the other portion, the position of the magnet in the radial direction can be defined, and occurrence of a leakage magnetic flux toward the outer peripheral side of the magnet can be suppressed.

### Appendix 10

The brushless motor according to Appendix 9, wherein the outer peripheral contact part is provided only at a portion of the outer peripheral end of the magnet in the circumferential direction.

According to the configuration of Appendix 10, since the outer peripheral contact part is provided only at a portion of the outer peripheral end of the magnet in the circumferential direction, the gap formed between the outer peripheral end of the magnet and the outer peripheral core part can suppress occurrence of a leakage magnetic flux toward the outer peripheral side of the magnet.

### Appendix 11

The brushless motor according to Appendix 9 or 10, wherein the outer peripheral contact part is provided only at a portion of the outer peripheral end of the magnet in an axial direction.

According to the configuration of Appendix 11, since the outer peripheral contact part is provided only at a portion of the outer peripheral end of the magnet in the axial direction, the gap formed between the outer peripheral end of the magnet and the outer peripheral core part can suppress occurrence of a leakage magnetic flux toward the outer peripheral side of the magnet.

### Appendix 12

The brushless motor according to any one of Appendices 8 to 11, wherein the outer peripheral contact part is in contact with the magnet at a central portion of the outer peripheral end of the magnet in the circumferential direction.

According to the configuration of Appendix 12, since the outer peripheral contact part is in contact with the magnet at the central portion of the outer peripheral end of the magnet in the circumferential direction, occurrence of a leakage magnetic flux toward the outer peripheral side of the magnet can be suppressed.

Reference Signs List

| 1, 101 Magnet | Magnet |
|---|---|
| 2, 2A, 2B, 2C, 2D, 2E, 102 | Electromagnetic steel sheet |
| 3, 3A, 103 | Annular portion |
| 4, 4A, 4B, 104 | Outer peripheral core part |
| 5, 5A, 5B, 105 | Bridge |
| 10, 10A, 10B, 10D, 10E, 110 | Rotor |
| 20, 20A, 20B, 20D, 20E, 120 | Core member |
| 42, 42A, 43 | Contact part |
| 44, 46, 144, 146 | Gap part |
| 45, 145 | Contact part |

1. A brushless motor comprising a rotor,
the rotor comprising:
a plurality of magnets arranged around a rotating shaft and sequentially arrayed with N poles or S poles facing each other in a circumferential direction;
a core member; and
a magnet holder arranged on two sides in an axial direction of the core member,
wherein the core member comprises: an annular portion around the rotating shaft; an outer peripheral core part which supports the plurality of magnets on an outer peripheral side of the annular portion; and a plurality of bridges which extend radially between the annular portion and the outer peripheral core part,
the magnet holder comprises a projecting part arrayed in the circumferential direction and projecting in the axial direction,
a through-hole penetrating in the axial direction is formed in the core member, and the magnet and the projecting part of the magnet holder are inserted into the through-hole,
the projecting part supports an inner peripheral surface of the magnet from an inner peripheral side,
each of the plurality of bridges is positioned between the magnets adjacent to each other in the circumferential direction, and
the plurality of bridges comprise one or more first bridges extending over a first range corresponding to a partial range of the core member along a direction of the rotating shaft.

2. The brushless motor according to claim 1, wherein the brushless motor comprises one or more second bridges extending over a second range that corresponds to a partial range of the core member and is different from the first range along the direction of the rotating shaft.

3. The brushless motor according to claim 1, wherein the first bridge is provided to be unevenly distributed in one direction of a rotating shaft direction in the core member.

4. The brushless motor according to claim 2, wherein the first bridge and the second bridge are alternately formed in the circumferential direction.

5. The brushless motor according to claim 1, wherein the outer peripheral core part comprises a contact part which contacts the respective magnets from the inner peripheral side, and
the contact part is located at a same position as the first bridge in a rotating shaft direction and contacts the inner peripheral surface of the magnet only on one side adjacent to the first bridge in the circumferential direction.

6. The brushless motor according to claim 1, wherein the outer peripheral core part comprises a contact part which contacts the respective magnets from the inner peripheral side, and
the contact part is located at a same position as the first bridge in a rotating shaft direction and contacts the inner peripheral surface of the magnet on two sides of the magnet in the circumferential direction.

7. The brushless motor according to claim 1, wherein the core member comprises:
a first member which constitutes the first bridge; and
a second member which comprises the outer peripheral core part and does not comprise any of the annular portion and the plurality of bridges.

8. The brushless motor according to claim 1, wherein the outer peripheral core part is formed with a gap part which forms a gap with respect to an outer peripheral end of the magnet.

9. The brushless motor according to claim 8, wherein the outer peripheral core part is formed with an outer peripheral contact part which contacts the magnet at a portion of the outer peripheral end of the magnet, and
the gap part is formed at a portion of the outer peripheral end of the magnet where the outer peripheral contact part is not in contact with the magnet.

10. The brushless motor according to claim 9, wherein the outer peripheral contact part is provided only at a portion of the outer peripheral end of the magnet in the circumferential direction.

11. The brushless motor according to claim 9, wherein the outer peripheral contact part is provided only at a portion of the outer peripheral end of the magnet in an axial direction.

12. The brushless motor according to claim 9, wherein the outer peripheral contact part is in contact with the magnet at a central portion of the outer peripheral end of the magnet in the circumferential direction.
